(19) United States
(12) Patent Application Publication
(10) Pub. No.: US 2026/0172885 A1
(43) Pub. Date: Jun. 18, 2026

(54) DEVICE AND METHOD FOR APPLICATION TRIGGERED DYNAMIC TRAFFIC HANDLING

(71) Applicant: HUAWEI TECHNOLOGIES CO., LTD., Shenzhen (CN)

(72) Inventors: Qing Wei, Munich (DE); Qi Pan, Beijing (CN); Wint Yi Poe, Munich (DE); Riccardo Trivisonno, Munich (DE); Hui Ni, Beijing (CN)

(73) Assignee: HUAWEI TECHNOLOGIES CO., LTD., Shenzhen (CN)

(21) Appl. No.: 19/461,447

(22) Filed: Jan. 27, 2026

Related U.S. Application Data
(63) Continuation of application No. PCT/CN2023/128485, filed on Oct. 31, 2023.

(51) Int. Cl. H04W 28/02

(52) U.S. Cl. CPC H04W 28/0236

(57) ABSTRACT

The present disclosure relates to a control entity, a network entity, and an application function (AF) for event-based traffic handling. The disclosure proposes a control entity that is configured to: obtain event-based handling information related to an application, wherein the event-based handling information indicates one or more trigger events, and one or more traffic treatments and/or treatment configurations corresponding to each trigger event; determine an event-based handling configuration based on the event-based handling information; and provide the event-based handling configuration to the network entity, wherein the event-based handling configuration indicates the network entity to perform event-based traffic handling for traffic from the application. This disclosure further proposes a network entity configured to obtain the event-based handling configuration, and perform event-based traffic handling for traffic from the application, based on the event-based handling configuration.

### CROSS-REFERENCE TO RELATED APPLICATIONS

This application is a continuation of International Application No. PCT/CN2023/128485, filed on Oct. 31, 2023, the disclosure of which is hereby incorporated by reference in its entirety.

### TECHNICAL FIELD

The present disclosure relates to communication networks, and particularly to traffic handling in communication networks. The disclosure proposes a control entity, a network entity, an application function (AF), and corresponding methods for event-based traffic handling in networks.

### BACKGROUND

Tactile and multi-modal communication services are used in many scenarios (e.g., industry, robotics, telepresence, virtual reality, augmented reality, healthcare, road traffic, serious gaming, education, etc.). Such services normally comprise mixed traffic (Video/Audio, sensor readings, and haptic data) and require low latency and high reliability for the interaction. It is extremely challenging to support such Real-Time (RT) media communication in mobile networks due to the agile wireless environment and big variations of the traffic demand in a certain area. The RT traffic exceeding the packet delivery latency budget will be considered lost by the application. The packet loss (especially the important ones) will greatly affect the User Service Experience which is indicated as Quality of Experience (QoE).

The transport layer or application layer provides different mechanisms to recover the media contents from the loss of an important packet during transmissions. However, such transport/application layer packets retransmission/insertion is transparent to the mobile network and therefore may not be efficient, i.e., can have additional delay. For instance, packets of an inserted Instantaneous Decoder Refresh (IDR) can only be transmitted after the ones already in the transmission queue of the mobile network although the queued ones may not need to be transmitted anymore. A retransmitted video frame or STREAM-FRAME will be transmitted after the ones already in the transmission queue of the mobile network although it may have a tighter deadline due to the retransmission.

Therefore, an advanced solution is desired, which can improve the efficiency of the application layer/transport mechanism (e.g., error recovery), and also improve the user QoE.

### SUMMARY

In view of the above-discussed limitations, this disclosure aims to reduce traffic latency when transported through a congested mobile network. One objective is to enable customized traffic treatments for different types of packets in the mobile network. Another objective is to adapt the treatment fast to the variation of application layer traffic characteristics. Another objective is to enable accurate traffic handling so as to improve network resource utilization.

These and other objectives are achieved by the solution of the present disclosure as provided in the enclosed independent claims. Advantageous implementations are further defined in the dependent claims.

A first aspect of the disclosure provides a control entity for controlling event-based traffic handling, configured to: obtain event-based handling information related to an application, wherein the event-based handling information indicates one or more trigger events, and one or more traffic treatments and/or treatment configurations corresponding to each trigger event; determine an event-based handling configuration based on the event-based handling information; and provide the event-based handling configuration to a network entity, wherein the event-based handling configuration indicates the network entity to perform event-based traffic handling for traffic from the application.

This disclosure further proposes a control entity that determines the event-based handling configuration (EbHC) based on the event-based handling configuration (EbHI) and provides the EbHC to the UP, so as to instruct the UP on performing certain traffic treatments on certain selected packets or packet sets, upon detection of the certain application event. Notably, the traffic is from the UP of an application (i.e., application server or application client). In this disclosure, a packet may be a Protocol Data Unit (PDU), which is a basic unit of packet transport in a 3GPP network. A packet set may be referred to as a PDU set, which includes one or more PDUs carrying the payload of one unit of information generated at the application level (e.g., frame(s) or video slice(s), etc., for Extended Reality (XR) Services).

In this way, this disclosure proposes a solution to support customized event-based traffic handling, where the network is able to control the traffic treatment according to application configuration based on UP events (e.g., receiving a certain type of PDU/PDU sets).

In an implementation form of the first aspect, the control entity is further configured to obtain the event-based handling information from the AF via a network exposure function (NEF) and/or a user data repository (UDR) function, or obtain the event-based handling information based on information preconfigured in the control entity.

The control entity, e.g., the Policy Control Function (PCF), may obtain some of the event-based handling information from the application via NEF and UDR. In one particular example, the control entity may obtain the event-based handling information, or at least a part of the event-based handling information, locally. In this example, the control entity may be the Session Management Function (SMF) in the CP, and the event-based handling information is preconfigured in the SMF.

In an implementation form of the first aspect, the event-based handling information comprises one or more of the following information:
a description of a trigger event, and/or an event ID indicating a trigger event;
one or more traffic treatments corresponding to a trigger event or an event ID, and
one or more treatment configurations corresponding to a trigger event or an event ID.

For instance, the event-based handling information can be implemented as a mapping table which consists of a list of application-specified application trigger events, the correspondent traffic treatment, and the target PDU(s).

In an implementation form of the first aspect, the one or more trigger events comprise one or more of the following events:
a packet or a packet set carrying an event ID with a certain value,
a packet or a packet set of a certain type, and
a packet or a packet set of certain importance.

Optionally, the trigger event here can be a detected packet carrying a certain event ID (e.g. in the packet header), a detected PDU/PDU set of a certain type, or a detected PDU/PDU set with a certain importance level. When such a packet or a packet set is detected, the event-based traffic handling is triggered.

In an implementation form of the first aspect, a type of a packet or a packet set comprises:
a packet or a packet set carrying an instantaneous decoder refresh (IDR) frame,
a packet or a packet set carrying a full intra-frame request (FIR),
a packet or a packet set indicating a negative acknowledgment (NACK), or
a retransmitted packet or a retransmitted packet set.

The type of a packet (PDU) or a packet set (PDU set) is a type considering carried application-level information (e.g., an I-frame or P-frame of a video). Examples of such PDU/PDU set types could be NACK, FIR, retransmitted, IDR, etc. The PDU/PDU set type can be explicitly indicated by the application in the packet header using a PDU/PDU set type ID, or using the PDU Set Importance (PSI).

In an implementation form of the first aspect, the one or more traffic treatments corresponding to a trigger event comprise one or more of the following:
adjust one or more parameters related to a target packet or a target packet set,
adjust one or more parameters related to handling a target packet or a target packet set,
drop a target packet or a target packet set,
preempt a target packet or a target packet set, and
manage a queue storing a target packet or a target packet set.

The traffic treatments include the parameter adjustment (e.g., timer adjustment, prioritize/deprioritize, etc.) and different actions (e.g., PDU(s) drop or preempt, empty the queue.), which are to be applied on one or more selected PDU(s)/PDU set(s) (which is named as target PDU(s) in this disclosure).

In an implementation form of the first aspect, the one or more treatment configurations corresponding to a trigger event comprise one or more of the following:
criteria for selecting one or more target packets or target packet sets,
timeout or extend a dropping timer for the one or more target packets or target packet sets,
prioritize or deprioritize the one or more target packets or target packet sets, and
adjust one or more quality of service (QoS) parameters related to the one or more target packets or target packet sets.

To allow customized PDU set treatment, treatment configurations for different types of PDU (set) are provided to the UP network entity for it to enforce the determined traffic treatments/configurations on certain PDU(s) upon the detection of a certain type of PDU/PDU set.

In an implementation form of the first aspect, the criteria for selecting one or more target packets or target packet sets comprises one or more of the following:
flow level criteria comprising flow information or traffic description,
packet or packet set level criteria comprising one or more of: transmission status, QoS parameter, a type of a packet or a packet set, importance of a packet or a packet set,
temporal criteria comprising a waiting time of a packet or a packet set in the queue, and/or arrival time of a packet or a packet set,
criteria to exclude a packet or a packet set that triggers a trigger event, and
criteria to select a packet or a packet set with relative parameters to the packet or the packet set that triggers the trigger event.

Notably, the target PDU(s) can include/exclude the trigger PDU/PDU set, i.e., the packet or the packet set that triggers a trigger event. For example, the related treatment may be defined for the PDUs in an outgoing queue with a certain arrival time. When the trigger PDU/PDU set (fulfilling the arrival time criteria), enters the same outgoing queue, it will also be treated accordingly.

In an implementation form of the first aspect, the target packet or the target packet set comprises one or more packets or packet sets that satisfy one or more of the criteria.

In an implementation form of the first aspect, the event-based handling configuration indicates the network entity to perform one or more traffic treatments and/or configurations on one or more target packets or target packet sets upon detecting the one or more trigger events.

That is, the UP network enforces the determined traffic treatments/configurations on certain PDU(s) upon the detection of a certain type of PDU/PDU set.

In an implementation form of the first aspect, the event-based handling configuration comprises one or more of the following:
a configuration/rule for a certain traffic treatment,
a configuration/rule for detecting the one or more trigger events,
a configuration/rule for identifying the one or more target packets or target packet sets,
a configuration/rule for marking the detected one or more trigger events in a packet header,
assistance information to map a certain detected trigger event to an event ID,
information to map one or more traffic treatments/configurations to a network action ID, and/or
information to map a certain configuration/rule for a certain traffic treatment to an event-based handling rule ID.

In particular, the EbHC can be implemented as UP entity configurations/rules/extended QoS which certain profile, indicate traffic treatments/configurations on target PDU(s) upon the detection of specified application trigger event (e.g., a certain type of PDU/PDU set).

In an implementation form of the first aspect, the network entity is an access network entity, wherein the control entity is further configured to provide the event-based handling information and/or the event-based handling configuration to the access network entity using a session modification procedure.

In one example, the control entity may be the SMF, and it may provide the EbHI/EbHC to the Radio Access Network (RAN), e.g., using the PDU session modification procedure.

A second aspect of the disclosure provides a network entity for performing event-based traffic handling, configured to: obtain event-based handling configuration from a control entity or a management entity, wherein the event-based handling configuration indicates the network entity to perform event-based traffic handling for traffic from an application; and perform event-based traffic handling for traffic from the application, based on the event-based handling configuration.

This disclosure proposes a network entity that enforces the determined traffic treatments/configurations on certain PDU(s) upon the detection of a certain type of PDU/PDU set. The event-based handling configuration may be provided by a CP entity (i.e., the control entity). Alternatively, the event-based handling configuration may be locally configured (by a management network entity) at the network entity.

In an implementation form of the second aspect, the network entity is further configured to perform one or more traffic treatments and/or configurations on one or more target packets or target packet sets upon detecting one or more trigger events, based on the event-based handling configuration.

In an implementation form of the second aspect, the event-based handling configuration comprises one or more of the following:
a configuration/rule for a certain traffic treatment,
a configuration/rule for detecting the one or more trigger events,
a configuration/rule for identifying the one or more target packets or target packet sets,
a configuration/rule for marking the detected one or more trigger events in a packet header,
assistance information to map a certain detected trigger event to an event ID,
information to map one or more traffic treatments/configurations to a network action ID, and/or
information to map a certain configuration/rule for a certain traffic treatment to an event-based handling rule ID.

In particular, the EbHC can be implemented as UP entity configurations/rules/extended Qos profile, which indicate certain traffic treatments/configurations on target PDU(s) upon the detection of specified application trigger event (e.g., a certain type of PDU/PDU set).

In an implementation form of the second aspect, the one or more trigger events comprise one or more of the following events:
a packet or a packet set carrying an event ID with a certain value,
a packet or a packet set of a certain type, and
a packet or a packet set of a certain importance.

Optionally, the trigger event here can be a detected packet carrying a certain event ID (e.g. in the packet header), a detected PDU/PDU set of a certain type, or a detected PDU/PDU set with a certain importance level. When such a packet or a packet set is detected, the event-based traffic handling is triggered.

In an implementation form of the second aspect, a type of a packet or a packet set comprises:
a packet or a packet set carrying an IDR, frame,
a packet or a packet set carrying a FIR,
a packet or a packet set indicating a NACK, or
a retransmitted packet or a retransmitted packet set.

The type of a packet (PDU) or a packet set (PDU set) is a type considering carried application-level information (e.g., an I-frame or P-frame of a video). Examples of such PDU/PDU set types could be NACK, FIR, retransmitted, IDR, etc. The PDU/PDU set type can be explicitly indicated by the application in the packet header using a PDU/PDU set type ID, or using the PSI.

In an implementation form of the second aspect, the one or more traffic treatments corresponding to a trigger event comprise one or more of the following:
adjust one or more parameters related to a target packet or a target packet set,
adjust one or more parameters related to handling a target packet or a target packet set,
drop a target packet or a target packet set,
preempt a target packet or a target packet set, and
manage a queue storing a target packet or a target packet set.

To allow customized PDU set treatment, treatment configurations for different types of PDU (set) are provided to the UP network entity for it to enforce the determined traffic treatments/configurations on certain PDU(s) upon the detection of a certain type of PDU/PDU set.

In an implementation form of the second aspect, the network entity is further configured to detect the one or more trigger events; and identify the one or more target packets or one or more target packet sets.

This disclosure proposes enhanced UPF operations at the network entity. Enhanced UPF operations may include such as: detecting the application trigger event (i.e., identifying a certain type or importance of a PDU/PDU set, and identifying the event ID carried by a PDU/PDU set).

In an implementation form of the second aspect, the network entity is a UP function (UPF), the network entity is configured to indicate the detected one or more trigger events to an access network entity by marking the detected one or more trigger events in a packet header.

Enhanced UPF operations may further comprise marking the detected trigger event in the GTP header, for instance, with an index number; and perform event-based treatments for target PDU(s).

In an implementation form of the second aspect, the network entity is further configured to mark the detected one or more trigger events in a packet header using one of the following implementations:
extending an existing packet type field,
reusing a PSI field,
using a new packet set type field, or
using a new event ID field.

Optionally, the detected trigger events can be indicated by the network entity (e.g., the UPF) in the GTP header to RAN with the above-mentioned options. It may be understood that if PSI is used as a trigger event, then there is no need for the UPF to mark it.

In an implementation form of the second aspect, the network entity is the access network entity, the network entity is configured to: obtain event-based handling information related to the application from the control entity, wherein the event-based handling information indicates one or more trigger events and one or more traffic treatments and/or treatment configurations corresponding to each trigger event; and perform the event-based traffic handling based on the event-based handling information and/or the event-based handling configuration.

In one example, the network entity may be the RAN, and the control entity (i.e., the SMF) may provide the EbHI/EbHC to the RAN, e.g., using the PDU session modification procedure.

In an implementation form of the second aspect, the network entity is further configured to provide an indication to the control entity, wherein the indication indicates that the network entity is capable of event-based traffic handling.

Optionally, when the network entity is capable of UP event-based handling, it may indicate the control entity, such as the SMF. Then SMF could use that indication for the selection of the UPF as well as the determination of the UPF configurations/rules for that UPF.

A third aspect of the disclosure provides an AF for assisting event-based traffic handling, which is configured to provide event-based handling information related to an application, to a control entity, wherein the event-based handling information indicates one or more trigger events and one or more traffic treatments and/or treatment configurations corresponding to each trigger event.

This disclosure further proposes an AF for providing the event-based handling information to the CP entity (i.e., the control entity, such as PCF or SMF), thereby configuring the network on event-based traffic handling.

In an implementation form of the third aspect, the AF is further configured to provide the event-based handling information to the control entity via a NEF and/or a UDR function.

In an implementation form of the third aspect, the AF is further configured to send a request to the NEF during the establishment of an AF session, wherein the request comprises the event-based handling information.

Possibly, the AF provides event-based handling information to the PCF via the NEF using the existing procedure for setting up an AF session with the required QoS. In this case, the AF sends a request to reserve resources for an AF session using a Nnef_AFsessionWithQoS_Create request message, which comprises the event-based handling information, to the NEF.

In an implementation form of the third aspect, the AF is further configured to provide the event-based handling information for future AF sessions to the UDR function.

Optionally, the AF may provide the event-based handling information per trigger event for future AF sessions in the UDR.

In an implementation form of the third aspect, the AF is further configured to mark the one or more trigger events with an index in a packet header.

Optionally, the AF could mark the trigger event with an index in the Real-time Transport Protocol (RTP) extension header directly at N6.

A fourth aspect of the disclosure provides a method for controlling event-based traffic handling performed by a control entity, comprises: obtaining event-based handling information related to an application, wherein the event-based handling information indicates one or more trigger events and one or more traffic treatments and/or treatment configurations corresponding to each trigger event; determining an event-based handling configuration based on the event-based handling information; and providing the event-based handling configuration to a network entity, wherein the event-based handling configuration indicates the network entity to perform event-based traffic handling for traffic from the application.

Implementation forms of the method of the fourth aspect may correspond to the implementation forms of the control entity of the first aspect described above. The method of the fourth aspect and its implementation forms achieve the same advantages and effects as described above for the control entity of the first aspect and its implementation forms.

A fifth aspect of the disclosure provides a method for performing event-based traffic handling performed by a network entity, comprises: obtain event-based handling configuration from a control entity or a management entity, wherein the event-based handling configuration indicates the network entity to perform event-based traffic handling for traffic from an application; and perform event-based traffic handling for traffic from the application, based on the event-based handling configuration.

Implementation forms of the method of the fifth aspect may correspond to the implementation forms of the network entity of the second aspect described above. The method of the fifth aspect and its implementation forms achieve the same advantages and effects as described above for the network entity of the second aspect and its implementation forms.

A sixth aspect of the disclosure provides a method for assisting event-based traffic handling performed by an AF, comprises providing event-based handling information related to an application, to a control entity, wherein the event-based handling information indicates one or more trigger events and one or more traffic treatments and/or treatment configurations corresponding to each trigger event.

Implementation forms of the method of the sixth aspect may correspond to the implementation forms of the AF of the third aspect described above. The method of the fifth aspect and its implementation forms achieve the same advantages and effects as described above for the AF of the third aspect and its implementation forms.

A seventh aspect of the disclosure provides a computer program product comprising a program code for carrying out, when implemented on a processor, the method according to the fourth aspect and any implementation forms of the fourth aspect, the fifth aspect, and any implementation forms of the fifth aspect, or the sixth aspect and any implementation forms of the sixth aspect.

An eighth aspect of the disclosure provides a computer-readable medium comprising instructions which, when executed by a computer, cause the computer to carry out, the method according to the fourth aspect and any implementation forms of the fourth aspect, the fifth aspect, and any implementation forms of the fifth aspect, or the sixth aspect and any implementation forms of the sixth aspect.

It has to be noted that all devices, elements, units, and means described in the present application could be implemented in software or hardware elements or any kind of combination thereof. All steps that are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity that performs that specific step or functionality, it should be clear for a skilled person that these methods and functionalities can be implemented in respective software or hardware elements or any kind of combination thereof.

### BRIEF DESCRIPTION OF DRAWINGS

The above-described aspects and implementation forms of the present disclosure will be explained in the following description of specific embodiments in relation to the enclosed drawings, in which:

FIG. 1 shows a video error recovery using NACK feedback message and new reference pictures;

FIG. 2 shows a video error recovery using NACK feedback message and retransmission;

FIG. 3 shows a one-byte RTP header extension format;

FIG. 4 shows a control entity according to an embodiment of this disclosure;

FIG. 5 shows a network entity according to an embodiment of this disclosure;

FIG. 6 shows an AF according to an embodiment of this disclosure;

FIG. 7 shows a deployment of proposed entities in 3GPP network architecture according to an embodiment of this disclosure;

FIG. 8 shows enhancement in the CP interaction according to an embodiment of this disclosure;

FIG. 9 shows enhancement on UPF rules according to an embodiment of this disclosure;

FIG. 10 shows an operation procedure of event-based handling at the UPF according to an embodiment of this disclosure;

FIG. 11 shows a PDU session UP protocol;

FIG. 12 shows a sequence diagram when setting up an AF session according to an embodiment of this disclosure;

FIG. 13 shows a sequence diagram when setting a policy for a future AF session according to an embodiment of this disclosure;

FIG. 14 shows a PCF-initiated policy association modification procedure according to an embodiment of this disclosure;

FIG. 15 shows a PDU session modification procedure according to an embodiment of this disclosure;

FIG. 16 shows RT Media Transport Protocol Configurations according to an embodiment of this disclosure;

FIG. 17 shows a method according to an embodiment of this disclosure;

FIG. 18 shows a method according to an embodiment of this disclosure; and

FIG. 19 shows a method according to an embodiment of this disclosure

### DETAILED DESCRIPTION OF EMBODIMENTS

Illustrative embodiments of a control entity, a network entity, an AF, and corresponding methods for event-based traffic handling are described in the following with reference to the figures. Although this description provides a detailed example of possible implementations, it should be noted that the details are intended to be exemplary and in no way limit the scope of the application.

Moreover, an embodiment or example may refer to other embodiments or examples. For example, any description including but not limited to terminology, element, process, explanation, and/or technical advantage mentioned in one embodiment or example may also apply to the other embodiments or examples.

As previously discussed, the transport layer or application layer provides a different mechanism to recover the media contents from the loss of an important packet during transmissions. One solution direction is the application layer's new transmission. The new transmission could be based on the same contents (e.g., selected retransmission of the lost packet(s)) or new contents (e.g., IDR). The new transmission could be for an individual packet or group of packets (e.g., a Quick User Datagram Protocol (UDP) Internet Connections (QUIC) STREAM frame, a video frame/slice).

For instance, the encoder may inject an IDR frame to stop propagated decode error at the decoder side (e.g., due to lost packet(s) in previous IDR or multiple reference frames). In H.264/H.265, an IDR frame specifies that no frame after the IDR frame can reference any frame before it.

QUIC packets can contain multiple frames of different types (ACK-eliciting/NON-ACK-eliciting frames) together. QUIC acknowledges each ACK-eliciting packet. Application data sent in STREAM frames is retransmitted in new STREAM frames so that the current stream will not be blocked by the retransmitted STREAM frames.

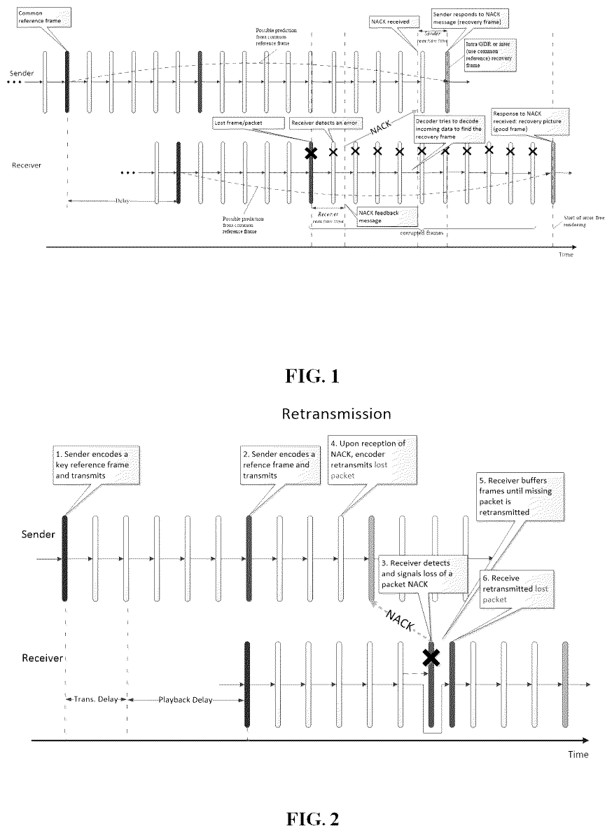

There are also other scenarios for video error recovery. FIG. 1 shows a video error recovery using a NACK feedback message and new reference pictures. It can be understood that when one or more PDUs in a reference picture get lost, the receiver detects the reference picture that is missing or has been partially received, and returns the error report as NACK feedback. Accordingly, the sender receives the NACK message and may generate another reference picture and send the recovery picture to the receiver.

In such cases, the IDR or reference picture may be inserted occasionally triggered by the packet loss event and the several pictures (e.g., video frames) that referred to the lost reference picture may be useless, while the not yet transmitted PDUs belonging to those pictures may still occupying the queue in RAN.

FIG. 2 shows a video error recovery using a NACK feedback message and retransmission. It can be understood that when one or more PDUs in a reference picture (blue) get lost, the receiver detects lost packets, issues a NACK message, and pauses decoding while caching incoming packets. When receiving the NACK message, the sender retransmits the requested packets. The receiver resumes decoding after receiving the requested packets.

In such case, the other packets in that picture if still in the queue in RAN can be kept longer in the queue for the transmission until the requested packets are received by the RAN. In another implementation option, the retransmitted packets in that picture should be transmitted before the ones in the queue, since it experiences more transmission delay due to the retransmission.

3GPP rel. 18 XR and Media Services (XRM) supports identifying the importance of a PDU set for the application based on the RTP header extension. The network may use that information to drop the less important ones (e.g., PDU set which carries a P-frame) in case of congestion.

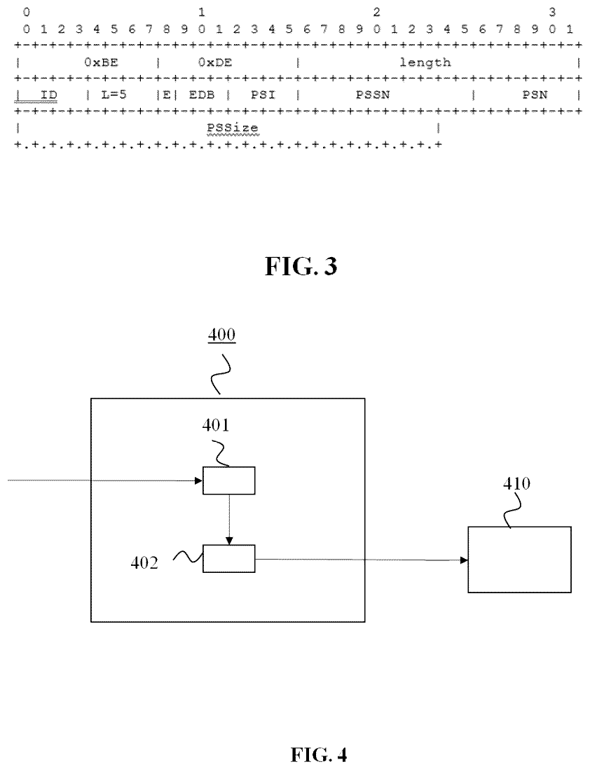

3GPP specifies PDU set information, which comprises: PDU Set Sequence Number (PSSN), Indication of End PDU of the PDU Set (E), PDU Sequence Number within a PDU Set (PSN), PDU Set Size in bytes (PSSize), and PDU Set Importance (PSI). PDU set information is provided by the application in the RTP extension header (as shown in FIG. 3) of each RTP packet when it enters the mobile network. Then UPF in the mobile network can identify the starting/ending of a PDU set, which PDU set a PDU belonging to, and the importance of a PDU set by inspecting the RTP header extension for downlink traffic. The UPF may pass the identified PDU set information further to RAN by marking the network header (i.e., GTP header). In case of network congestion, RAN may drop the less important PDU(s) (which belong to a PDU set with a lower importance level) in a media flow.

However, none of the existing solutions provides support for customized PDU set treatment configurations from the application. The types of PDU sets can be quite different for different application protocols (e.g., the PDU set carrying IDR frame, the PDU Set carrying FIR, the PDU Set carrying the Picture Loss Indication (PLI), the PDU Set carrying the Redundant Encoding (RED)) and/or transport protocols (e.g., PDU set carrying QUIC STREAM frames, PDU set carrying QUIC acknowledgment (ACK) frames, etc.). The required treatment per PDU set type in the network depends on the logic of application/transport protocols. The network normally does not know the logic of application/transport protocols, especially when the application layer traffic is encrypted. Therefore, the application must tell the network what type of treatment is required for which type of PDU set.

None of the existing solutions provides support for multiple types of PDU set treatment in a QoS flow. Application layer protocol and transport layer protocol are very diverse and can have very different sets of PDU set types including both the one carrying application layer/transport layer Control Plane contents (e.g., Real-Time Transport Control Protocol (RTCP), ACK/NACK) and the one carrying application layer UP contents (e.g., RTP, retransmission, video/audio I-frame, video/audio P-frame, haptic information, etc.). Different types of PDU set requires different types of handling. However, the current 3GPP mobile network knows only PDU set importance and supports only simple priority-based treatment. This could not meet the differentiated treatment requirements of a wide variety of PDU set types.

3GPP rel. 18 PDU set differentiated handling only supports per PDU treatment based on the PDU set importance of this PDU in case of network congestion. It is not possible to affect/“control” the treatment of other PDUs of this application in the network (e.g., remove the PDU set not needed anymore in the transmission queue). On the other hand, CP-based handling adjustment (such as AF requested QoS session in the current 3GPP network [1]) is not suitable for very dynamic traffic handling due to the long signaling path from application to 5GC CP to 5GC UP and related delay. That is, none of the existing solutions provides support for “UP event-based handling” (e.g., empty the transmission queue based on a certain detected PDU set type in the UP).

The goal of the present disclosure is to reduce the end-to-end (e2e) latency of media-type traffic when transported through a congested mobile network. Based on the PDU set QoS support in 3GPP Rel. 18, this disclosure addresses the technical problems like how to support customized PDU set treatment configuration for different types of PDU set in the mobile network, and how to adapt the PDU set treatment fast to the variation of application layer traffic characteristics.

This disclosure proposes a control entity, a network entity, and an AF, for controlling, performing, and assisting event-based traffic handling in application traffic flows.

FIG. 4 shows a control entity 400 adapted for controlling event-based traffic handling, according to an embodiment of the disclosure. In particular, the “event” refers to a UP event that triggers a certain UP treatment in the mobile network.

The control entity 400 may comprise processing circuitry (not shown) configured to perform, conduct, or initiate the various operations of the control entity 400 described herein. The processing circuitry may comprise hardware and software. The hardware may comprise analog circuitry digital circuitry, or both analog and digital circuitry. The digital circuitry may comprise components such as application-specific integrated circuits (ASICs), field-programmable arrays (FPGAs), digital signal processors (DSPs), or multi-purpose processors. The control entity 400 may further comprise memory circuitry, which stores one or more instruction(s) that can be executed by the processor or by the processing circuitry, in particular under the control of the software. For instance, the memory circuitry may comprise a non-transitory storage medium storing executable software code which, when executed by the processor or the processing circuitry, causes the various operations of the control entity 400 to be performed. In one embodiment, the processing circuitry comprises one or more processors and a non-transitory memory connected to one or more processors. The non-transitory memory may carry executable program code which, when executed by one or more processors, causes the control entity 400 to perform, conduct, or initiate the operations or methods described herein.

The control entity 400 is configured to obtain event-based handling information 401 related to an application. In particular, the event-based handling information 401 indicates one or more trigger events, and one or more traffic treatments and/or treatment configurations corresponding to each trigger event. The trigger event is a UP event that triggers a certain UP treatment in the mobile network.

The control entity 400 is further configured to determine an event-based handling configuration 402 based on the event-based handling information 401, and provide the event-based handling configuration 402 to a network entity 410. The event-based handling configuration 402 indicates the network entity 410 to perform event-based traffic handling for traffic from the application.

This disclosure proposes a control entity 400 that enables the network to control the traffic treatment according to application configuration based on UP events. In particular, the control entity 400 may be a CP network entity that determines the event-based handling configuration (EbHC), and provides it to UPF, thereby instructing the UP on performing certain traffic treatments, detection of certain application events, identification of the target PDU(s). For example, the control entity 400 may be the PCF or the SMF in the CP. The network entity 410 may be the RAN or UPF in the UP.

In one implementation, the control entity 400 is configured to obtain the event-based handling information 401 from an AF 420 via a NEF, and/or a UDR function. Alternatively, the control entity 400 may be configured to obtain the event-based handling information 401 based on information preconfigured in the control entity 400.

Optionally, the event-based handling configuration 402 indicates the network entity 410 to perform one or more traffic treatments and/or configurations on one or more target packets or target packet sets upon detecting the one or more trigger events.

Accordingly, this disclosure also proposes a network entity that enforces the determined traffic treatments/configurations on certain PDU(s) upon the detection of a certain type of PDU/PDU set. Notably, the network entity may be a UP network entity.

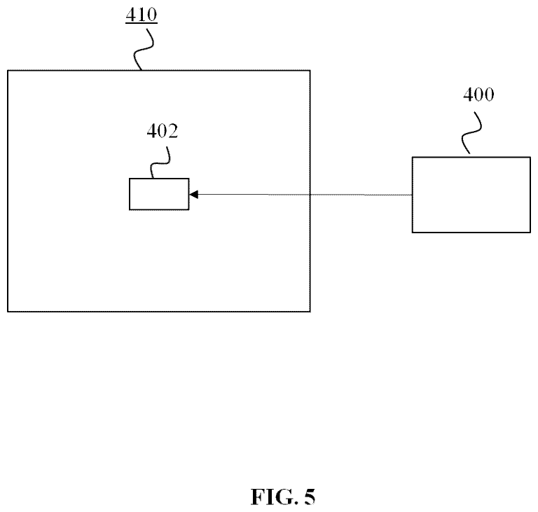

FIG. 5 shows a network entity 410 adapted for performing event-based traffic handling, according to an embodiment of the disclosure. In particular, the network entity 410 is configured to obtain event-based handling configuration 402 from a control entity 400 or a management entity, wherein the event-based handling configuration 402 indicates the network entity 410 to perform event-based traffic handling for traffic from an application. Then the network entity 410 is further configured to perform event-based traffic handling for traffic from the application, based on the event-based handling configuration 402. Notably, the control entity 400 may be the control entity 400 as shown in FIG. 4.

The network entity 410 may comprise processing circuitry (not shown) configured to perform, conduct, or initiate the various operations of the network entity 410 described herein. The processing circuitry may comprise hardware and software. The hardware may comprise analog circuitry digital circuitry, or both analog and digital circuitry. The digital circuitry may comprise components such as application-specific integrated circuits (ASICs), field-programmable arrays (FPGAs), digital signal processors (DSPs), or multi-purpose processors. The network entity 410 may further comprise memory circuitry, which stores one or more instruction(s) that can be executed by the processor or by the processing circuitry, in particular under the control of the software. For instance, the memory circuitry may comprise a non-transitory storage medium storing executable software code which, when executed by the processor or the processing circuitry, causes the various operations of the network entity 410 to be performed. In one embodiment, the processing circuitry comprises one or more processors and a non-transitory memory connected to one or more processors. The non-transitory memory may carry executable program code which, when executed by one or more processors, causes the network entity 410 to perform, conduct, or initiate the operations or methods described herein.

According to an embodiment of this disclosure, the network entity 410 may be further configured to perform one or more traffic treatments and/or configurations on one or more target packets or target packet sets upon detecting one or more trigger events, based on the event-based handling configuration 402.

Notably, a target packet or target packet set refers to a PDU or a set of PDUs where certain UP treatments apply.

According to an embodiment of this disclosure, the network entity 410 may be further configured to provide an indication to the control entity 400, wherein the indication indicates that the network entity 410 is capable of event-based traffic handling.

In this embodiment, the network entity 410 may be the UPF. UPF, which is capable of UP event-based handling, may provide the indication to the control entity 400, e.g., the SMF. Then the control entity 400 could use that indication for the selection of the UPF as well as the determination of the UPF configurations/rules for that UPF.

In addition, this disclosure further proposes an application network entity (e.g., AF), which configures the network on event-based traffic handling by provision to CP network entity the event-based handling information that defines certain traffic handling (e.g., packet drop) for certain PDU(s) (i.e., target PDU(s)) under a certain application event (e.g., send a certain type of PDU/PDU set).

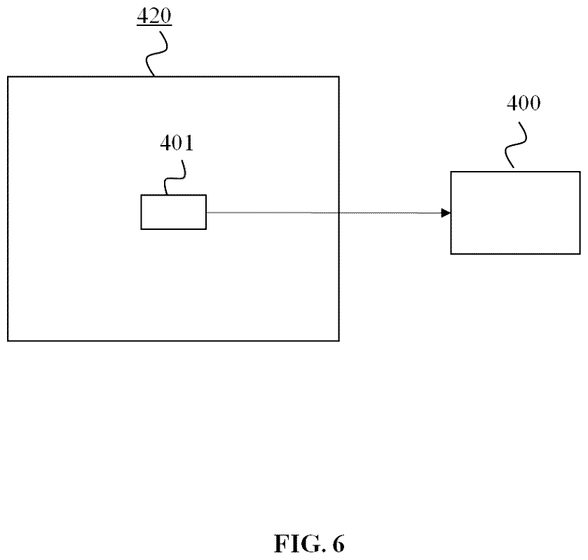

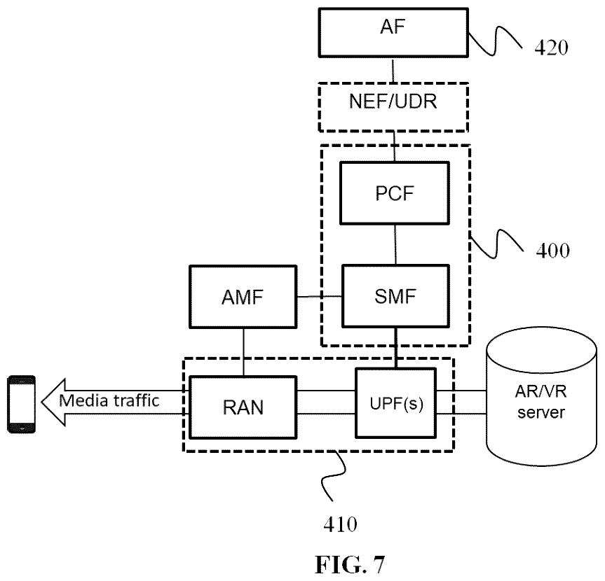

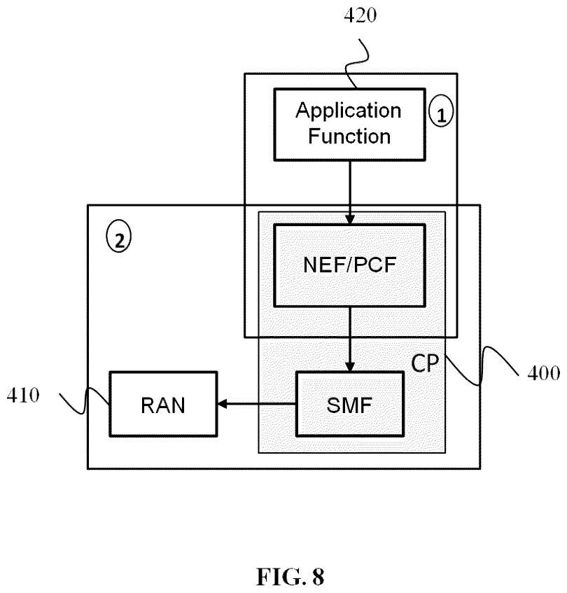

FIG. 6 shows an AF 420 adapted for assisting event-based traffic handling, according to an embodiment of the disclosure. In particular, the AF 420 is configured to provide event-based handling information 401 related to an application, to a control entity 400. In particular, the event-based handling information 401 indicates one or more trigger events and one or more traffic treatments and/or treatment configurations corresponding to each trigger event. Notably, the control entity 400 may be the control entity 400 as shown in FIG. 4.

According to an embodiment of this disclosure, the AF 420 may be further configured to provide the event-based handling information 401 to the control entity 400 via a NEF and/or a UDR function.

FIG. 7 shows an example deployment of the proposed network entities in 3GPP network architecture as enhanced AF, enhanced PCF/SMF, and enhanced RAN/UPF. The AF provides the event-based handling information 401 to the PCF via the NEF/UDR. The downlink traffic is discussed here.

In this embodiment, the control entity 400 may be the PCF or the SMF in the CP. The network entity 410 may be the RAN or the UPF in the UP.

The PCF/SMF determines the EbHC based on the EbHI and provides the EbHC to the RAN/UPF (e.g., as UPF configuration/UPF rules). The UPF performs the event-based traffic handling based on the EbHC. In another implementation, the SMF provides the EbHC to the RAN (e.g., as part of the QoS profile). The RAN, instead of the UPF, performs event-based traffic handling. The UPF only performs the detection of the application event and marks that in the downlink traffic (e.g., indicate the detected event ID in the network header) to pass the detected trigger event to the RAN.

Details about the event-based handling information 401 (i.e., the EbHI), and the event-based handling configuration 402 (i.e., the EbHC) are discussed in the following part.

FIG. 8 illustrates the required enhancement on the CP interactions where the application provides 5GS traffic treatment (e.g., packet transmission/queue management configurations) per event trigger.

In the first aspect, an AF-NEF/PCF interaction may use a mapping table indicating the EbHI. The EbHI indicates the mapping between a certain trigger event and related traffic treatment, and treatment configurations. Exemplary contents of EbHI are shown in detail in Table 1. In particular, Table 1 shows a mapping table of the trigger event, treatment category, and treatment configuration.

TABLE 1

| index | Trigger-Event | Treatment | Treatment configuration |
|---|---|---|---|
| 1 | Packet with a | parameter | Timeout/extend the PDU(s) dropping |
| | certain Event ID, | adjustment | timer (by a fixed time duration or |
| | or PDU/PDU set | | until a certain event; |
| | importance or | | (de)prioritize the PDU(s), using a different |
| | type (e.g., NACK, | | set of QoS parameters (e.g., QoS |
| | retransmitted, FIR) | | profile => Alternative QoS profile 1); |
| | | | Criteria for PDU selection (e.g., with |
| | | | same/lower importance, of a certain type). |
| 2 | | PDU(s) | Criteria for PDU selection (e.g., traffic |
| | | drop/preempt/ | description/flow ID, waiting time in the |
| | | queue empty | Queue (e.g., exceed PDB/PSDB), arrival |
| | | | time (e.g., in a fixed time range relative |
| | | | to the trigger event, from/until a |
| | | | certain event) |
| 3 | | | |

According to an embodiment of this disclosure, the event-based handling information 401 comprises one or more of the following information:
a description of a trigger event, and/or an event ID indicating a trigger event;
one or more traffic treatments corresponding to a trigger event or an event ID, and
one or more treatment configurations corresponding to a trigger event or an event ID.

Optionally, the one or more trigger events comprise one or more of the following events:
a packet or a packet set carrying an event ID with a certain value,
a packet or a packet set of a certain type, and
a packet or a packet set of certain importance.

Optionally, a type of a packet or a packet set comprises:
a packet or a packet set carrying an IDR frame,
a packet or a packet set carrying a FIR,
a packet or a packet set indicating a NACK, or
a retransmitted packet or a retransmitted packet set.

Notably, the trigger event here can be a detected packet carrying a certain event ID (e.g., in the packet header) or a detected PDU/PDU set of a certain type. Examples of such PDU/PDU set types could be NACK, FIR, retransmitted, IDR, etc. The PDU/PDU set type can be explicitly indicated by the application in the packet header using a PDU/PDU set type ID, or using the PSI. The PDU/PDU set type can also be derived by the network based on the traffic characteristic of such type of PDU/PDU set provided by the application. For example, the first 100 PDUs of a burst are type 1 PDUs. For another example, a PDU set with size 5-10 bytes is the PDU set of type 2.

It may be worth mentioning that, a packet set or a PDU set discussed in this disclosure, denotes a set of packets that has similar importance for the application and requires similar Quality of Service (QoS) treatment in the network. Notably, the importance of a packet or a packet set may be indicated by a value. It can be understood that when packet (or packet set) A has an importance level higher than packet (or packet set) B, it means packet A is more important than packet B.

According to an embodiment of this disclosure, the one or more traffic treatments corresponding to a trigger event comprise one or more of the following:
adjust one or more parameters related to a target packet or a target packet set,
adjust one or more parameters related to handling a target packet or a target packet set,
drop a target packet or a target packet set,
preempt a target packet or a target packet set, and
manage a queue storing a target packet or a target packet set.

In other words, the traffic treatments or network treatments may include the parameter adjustment (e.g., timer adjustment, prioritize/deprioritize, etc.) and different actions (e.g., PDU(s) drop or preempt, or empty the queue.). The network treatment applies to one or more selected PDU(s)/PDU set(s) (which is named as target PDU(s) in this disclosure) based on the criteria for PDU selection. Notably, a target packet or target packet set refers to a PDU or a set of PDUs where certain traffic treatments apply. It may be understood that the target PDUs may include or exclude the triggering PDU/PDU set.

In one example, when an FIR (i.e., trigger event) is detected in the RTCP feedback report in the uplink direction, the corresponding treatment may be to empty the blocked queue in the downlink direction in the RAN. In another example, when a new IDR is detected in the downlink direction, the corresponding treatment may be to empty the blocked queue in the downlink direction in the RAN. In another example, when the RED is detected in the downlink direction, the corresponding treatment may be to discard the redundant PDU Set in the downlink if necessary.

According to an embodiment of this disclosure, the one or more treatment configurations corresponding to a trigger event comprise one or more of the following:
criteria for selecting one or more target packets or target packet sets,
timeout or extend a dropping timer for the one or more target packets or target packet sets,
prioritize or deprioritize the one or more target packets or target packet sets, and
adjust one or more quality of service, QoS, parameters related to the one or more target packets or target packet sets.

According to an embodiment of this disclosure, the criteria for selecting one or more target packets or target packet sets comprises one or more of the following:
flow level criteria comprising flow information or traffic description,
packet or packet set level criteria comprising one or more of: transmission status, QoS parameter, a type of a packet or a packet set, importance of a packet or a packet set, set,
temporal criteria comprising a waiting time of a packet or a packet set in the queue, and/or arrival time of a packet or a packet set,
criteria to exclude a packet or a packet set that triggers a trigger event, and
criteria to select a packet or a packet set with relative parameters to the packet or the packet set that triggers the trigger event.

Possibly, the target packet or the target packet set comprises one or more packets or packet sets that satisfy one or more of the criteria

In case the identification of a certain PDU/PDU set type is based on traffic characteristics, the application may include such traffic characteristics in the EbHI.

The second aspect of FIG. 8 provides a PCF-SMF-RAN interaction to provide EbHC to RAN and SMF together with the QoS profile of the QoS flow.

The present disclosure provides an enhancement on CP-UP interaction. In particular, for downlink, SMF configures the UPF packet detection rule (PDR) to detect the trigger event. SMF configures the UPF forwarding action rule (FAR) on event-based treatment and detailed treatment parameters based on the EbHI. Optional, SMF may also configure the UPF rule to indicate the detected trigger event to RAN (e.g., marking in the RTP header). For uplink, SMF instructs the UE (via QoS rule) to detect the trigger event and indicate it to the Access Stratum (AS) layer based on the EbHI.

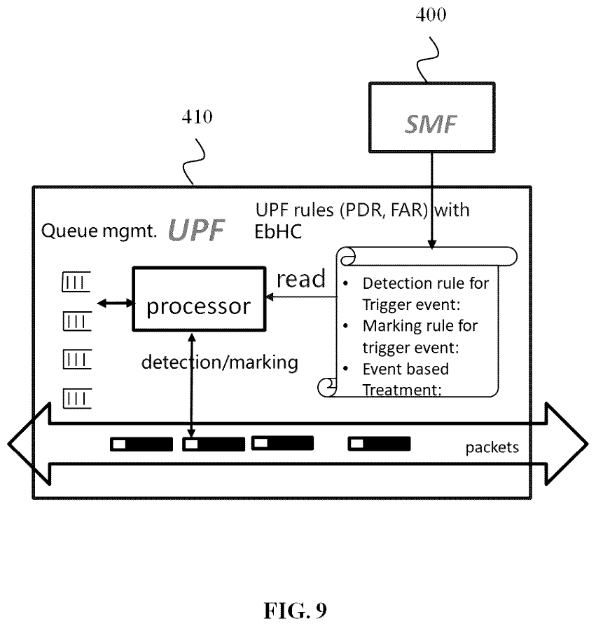

FIG. 9 shows an enhanced UPF according to an embodiment of the disclosure. Notably, the UPF shown here may be the network entity 410 shown in FIG. 4. Embodiments of this disclosure propose to enhance the UPF in two aspects for supporting the event-based traffic handling at UPF.

First, enhanced UPF configurations/rules to include the event-based handling configuration as shown in FIG. 9, is proposed. Enhanced UPF configurations/rules include the one used for the detection of the Trigger event and/or target PDU(s), the one used to mark the detected event in the packet header (e.g., GTP header), the one used for certain treatment (e.g., Queue management, QoS parameter adjustment, packet dropping/preempt, etc.). Such type of enhanced UPF rules needs to be stored at the UPF after received/updated from the SMF.

According to an embodiment of this disclosure, the event-based handling configuration 402 comprises one or more of the following:
a configuration/rule for a certain traffic treatment,
a configuration/rule for detecting the one or more trigger events,
a configuration/rule for identifying the one or more target packets or target packet sets,
a configuration/rule for marking the detected one or more trigger events in a packet header,
assistance information to map a certain detected trigger event to an event ID,
information to map one or more traffic treatments/configurations to a network action ID, and/or
information to map a certain configuration/rule for a certain traffic treatment to an event-based handling rule ID.

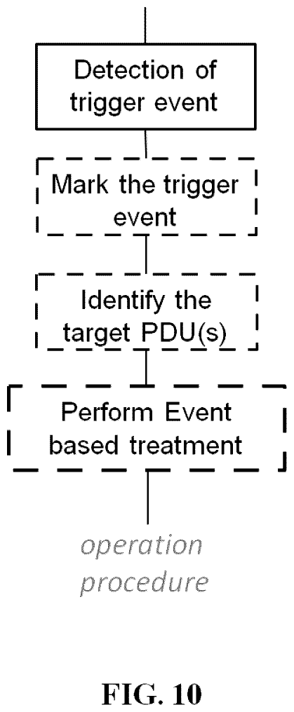

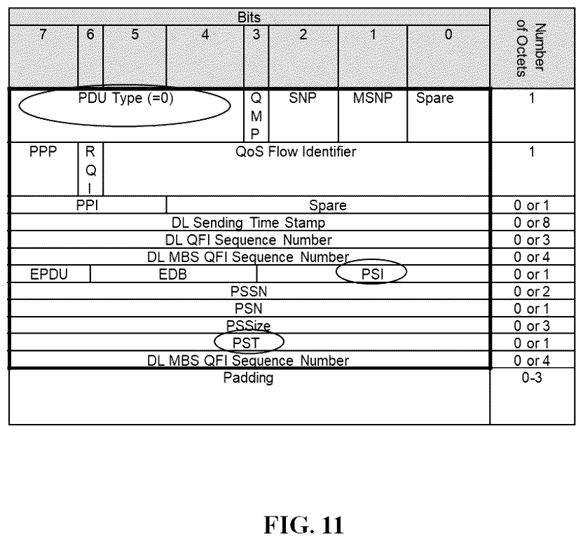

Second, enhanced UPF operations are proposed. FIG. 10 shows an operation procedure of event-based handling at the UPF according to an embodiment of the disclosure. Enhanced UPF operation may include such as: detecting the application trigger event (i.e., identify a certain type or importance of a PDU/PDU set, identify the event ID carried by a PDU/PDU set); mark the detected trigger event in the GTP header, for instance, with an index number; and perform event-based treatments for target PDU(s).

Optionally, the event-based treatments may comprise one or more of the following:
drop the selected PDU(s) (i.e., target packet or target packet set), e.g., if the delay of the selected PDU>Packet Delay Budget (PDB)/Packet Delay Budget (PSDB), and/or if the selected PDU with a lower importance,
set the drop timeout of the selected PDU(s) to 0, and
(de) prioritize the transmission of selected PDU(s), e.g., set it to a different priority level.

According to an embodiment of this disclosure, the network entity 410 may be configured to detect the one or more trigger events; and identify the one or more target packets or one or more target packet sets.

According to an embodiment of this disclosure, the network entity 410, which is the UPF, may be further configured to indicate the detected one or more trigger events to an access network entity by marking the detected one or more trigger events in a packet header.

The detected trigger event can be indicated by the UPF in the GTP header to RAN with the following options: extend the existing PDU Type field, reuse the PSI field, use a new field PST, or use a new field EID. t should be noted that if PSI is used as a trigger event, then there is no need for UPF to mark it.

Optionally, the network entity 410 may be configured to mark the detected one or more trigger events in a packet header using one of the following implementations:
extending an existing packet type field,
reusing a packet set importance field,
using a new packet set type field, or
using a new event ID field.

FIG. 11 shows a TS 38.415 PDU session UP protocol. In particular, the field “PDU Type” takes the value of the PDU Type it identifies, for instance, 0=DL PDU SESSION INFORMATION, 1=UL PDU SESSION INFORMATION, 2-15=reserved for future PDU type extension The field “PDU Set Importance [PSI]” may include 4 bits, and indicate the importance of this PDU Set compared to other PDU Sets within the same QoS flow.

Possibly, the reserved value in the “PDU Type” field can be used in this disclosure to indicate the PDU type from application layer perspectives as a trigger event. For example, 2 for downlink application PDU type 1, where PDU type 1 is also the trigger event with ID 1. Optionally, the PSI value can be reused to indicate the PDU set type, e.g., PSI=1 means PDU set of type 1, where the PDU set of type 1 is also the trigger event with ID 1.

In another example, a new Information Element of PST/EID can be introduced, e.g., as the following: a field “PDU/PDU set type [PST]/trigger event ID [EID]”, which includes 4˜8 bits, and comprises an index indicates the type of this PDU/PDU set, or event ID carried by this PDU/PDU set (from the application). Here the “PST” indicates the PDU set type ID, and “EID” indicates the ID of trigger event ID.

Possibly, the trigger PDU set may only marked in the first PDU or the last PDU in a PDU set. The trigger PDUs/trigger PDU sets can be further distinguished with different PST/EID values.

According to an embodiment of this disclosure, the criteria for selecting one or more target packets or target packet sets includes any of the following or a combination:
flow level criteria comprising flow information or traffic description,
packet or packet set level criteria comprising one or more of: transmission status, QoS parameter, a type of a packet or a packet set, importance of a packet or a packet set,
temporal criteria comprising a waiting time of a packet or a packet set in the queue, and/or arrival time of a packet or a packet set,
criteria to exclude a packet or a packet set that triggers a trigger event, and
criteria to select a packet or a packet set with relative parameters to the packet or the packet set that triggers the trigger event.

The flow level criteria may comprise service data flow (SDF) (e.g., 5 tuple), QoS flow identifier (QFI), and QoS profile (e.g., 5G QoS identifier (5QI), flow priority). The PDU/PDU set level criteria may comprise transmission status (e.g., latency>PDB, PSDB, number of failed retransmissions), QoS parameters (e.g., PDU/PDU set importance), and PDU/PDU set type.

The temporal criteria may include e.g., waiting time in the queue, and arrival time.

Examples of criteria for PDU selection include PDU/PDU set type, PSI, traffic description/flow ID, waiting time in the Queue (e.g., exceed PDB/PSDB), arrival time (e.g., in a fixed time range relative to the trigger event, from/until a certain event), etc. The selection could also be based on different Queues in the UP entity.

The target PDU(s) can include/exclude the trigger PDU/PDU set. e.g., the related treatment is for the PDUs in an outgoing queue with a certain arrival time. When the trigger PDU/PDU set (fulfilling the arrival time criteria), enters the same outgoing queue, it will also be treated accordingly.

According to an embodiment of the disclosure, AF, i.e., the AF 420, may provide event-based handling information of a flow to PCF via NEF using the existing procedure of “Setting up an AF session with required QoS” per application trigger event.

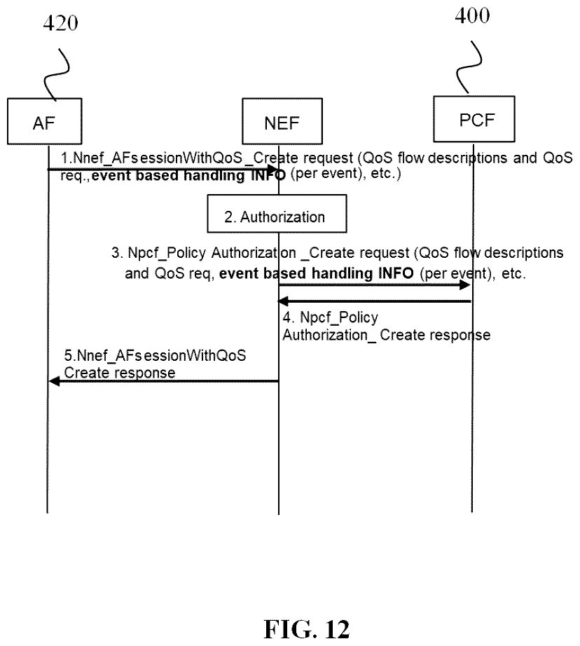

FIG. 12 shows an embodiment of setting up an AF session with the required QoS, according to this disclosure. Notably, the PCF may be the control entity 400 as shown in FIG. 4.

In particular, the following steps are performed:

Step 1: The AF sends a request to reserve resources for an AF session using the Nnef_AFsessionWithQoS_Create request message. In particular, this message may include AF Identifier, UE address, Flow description(s), QoS reference, and optional alternative service requirements (containing one or more QoS reference parameters in a prioritized order). In addition, the message also includes event-based handling information, i.e., the event-based handling information 401 as shown in FIG. 4 or FIG. 6, which indicates information about the event trigger, event-based treatment configuration, and target PDU(s), to the NEF.

Optionally, a period of time or a traffic volume for the requested QoS can be included in the AF request. The NEF assigns a Transaction Reference ID to the Nnef_AFsessionWithQoS_Create request.

According to this embodiment, the AF 420 is configured to send a request to the NEF during the establishment of an AF 420 session, wherein the request comprises the event-based handling information 401.

Step 2: The NEF authorizes the AF request and may apply policies to control the overall amount of pre-defined QoS authorized for the AF. If the authorization is not granted, steps 3 and 4 are skipped and the NEF replies to the AF with a result value indicating that the authorization failed.

Step 3: The NEF interacts with the PCF by triggering a Npcf_PolicyAuthorization_Create request and provides to the PCF, e.g., the AF Identifier, UE address, Flow description(s), the QoS reference, the optional alternative service requirements (containing one or more QoS reference parameters in a prioritized order, and the event-based handling information 401. Any optionally received period of time or traffic volume is also included and mapped to sponsored data connectivity information, for instance as defined in TS 23.203.

Step 4 and Step 5 are the same as a standard AF setup procedure.

Notably, the AF may send a Nnef_AFsessionWithQoS_Revoke request to the NEF in order to revoke the AF request. The NEF authorizes the revoke request and triggers the Npcf_PolicyAuthorization_Delete and the Npcf_PolicyAuthorization_Unsubscribe operations for the AF request.

In another embodiment, the control entity 400 (the PCF) may obtain some of the event-based handling information from the application via the NEF and UDR. FIG. 12 shows a procedure for setting a policy for a future AF session according to an embodiment of this disclosure.

According to an embodiment of the disclosure, the AF 420 may be further configured to provide the event-based handling information 401 for future AF sessions to the UDR function, as shown in Step 1.

In particular, the AF 420 may provide event-based handing information 401 per trigger event for future AF sessions in the UDR. The PCF subscribes to the UDR on certain applications using the application ID. Then, the PCF may combine information received via the UDR and information received directly from AF via NEF (e.g., a mandatory event trigger can be stored in the UDR, optional or newly defined event trigger can be added via AF interaction). Default handling configuration can be stored in the UDR and dedicated/dynamic configurations can be provided via AF interaction.

Table 2 shows an example of event-based handling information 401 stored in the UDR.

TABLE 2

| | |
|---|---|
| Parameters | Description |

Trigger event
Event-based treatment
Action/treatment
Target PDU(s)
Action configurations

According to an embodiment of the disclosure, the control entity 400 (PCF) may provide the event-based handling information 401 per event (with the QoS profile of each QoS flow) using the existing SM policy association procedure.

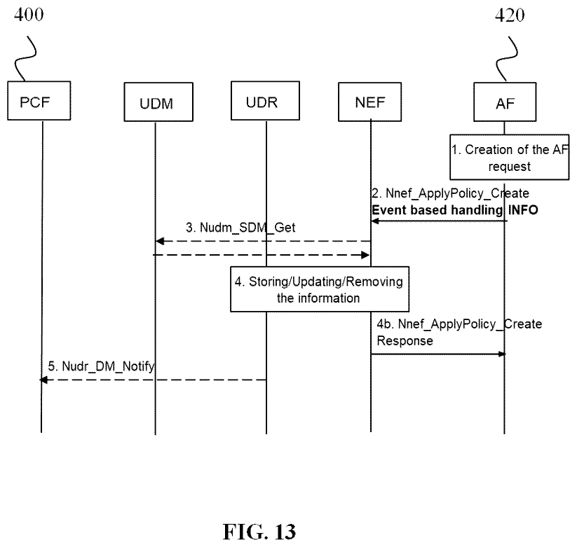

In particular, the SMF obtains the event-based handling information 401 locally and/or from the PCF using the SMF policy association establishment/modification procedure. FIG. 13 shows a PCF-initiated policy association modification procedure according to an embodiment of the disclosure.

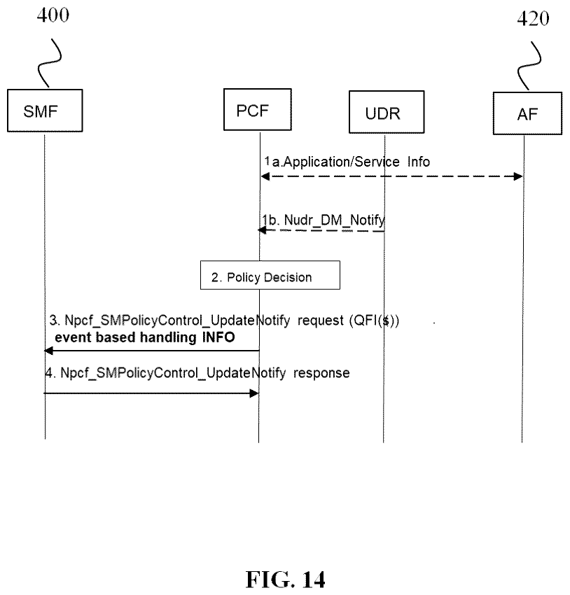

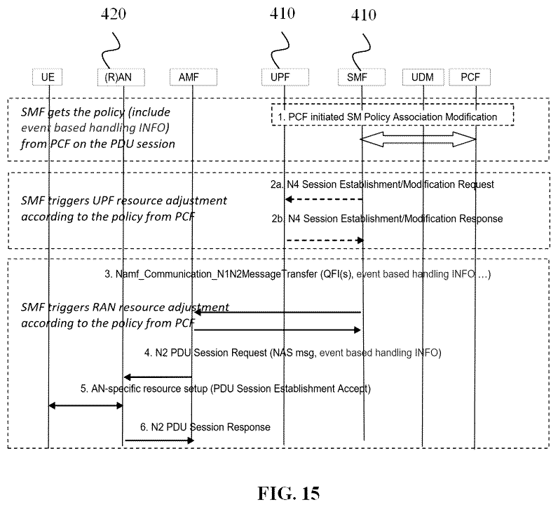

Then, the SMF provides the event-based handling information 401 and/or the event-based handling configuration 402 to RAN using the PDU session modification procedure. FIG. 14 shows a PDU session modification procedure according to an embodiment of the disclosure.

In one embodiment, this disclosure provides enhancement on the CP-UP interaction for RAN. According to an embodiment of this disclosure, RAN configures (RAN AS layer/UE) on event-based transmission according to the indication of event trigger in the GTP header (for downlink traffic) or detected by the UE (uplink traffic). RAN may also configure the detailed transmission parameters/handling (e.g., priority, transmission timeout timer, packet drop/preemption) based on event-based handling information 401 and/or the event-based handling configuration 402.

According to an embodiment of this disclosure, the application could mark the trigger event with an index in the RTP extension header directly at N6. For instance, the trigger event may be marked in the field of PDU type, PDU set type, PST, or EID (4˜8 bits), particularly with an index indicating the type of this PDU/PDU set, or an event ID carried by this PDU/PDU set. In another example, a trigger PDU set may only marked in the first PDU or the last PDU in a PDU set. Trigger PDU/trigger PDU set can be distinguished with different index values.

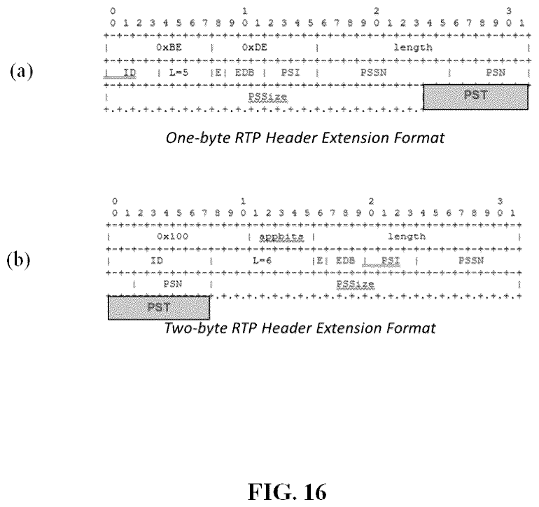

In the examples of FIGS. 16 (a) and 10 (b), a one-byte RTP header extension format and a two-byte RTP header extension format.

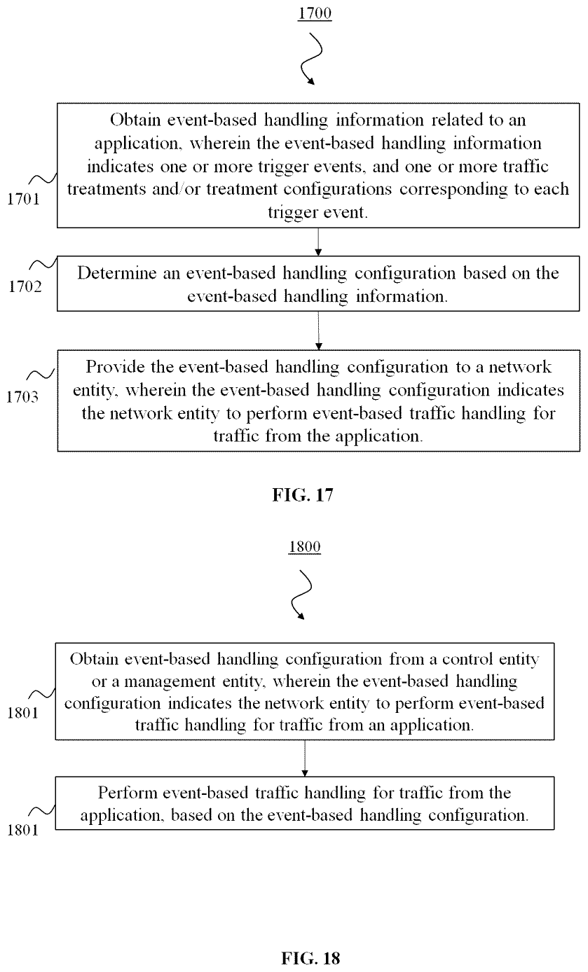

FIG. 17 shows a method 1700 according to an embodiment of the disclosure, particularly for controlling event-based traffic handling. In a particular embodiment, the method 1700 is performed by the control entity 400 shown in one of FIG. 4, FIG. 5, and FIG. 6. The method 1700 comprises a step 1701 of obtaining event-based handling information 401 related to an application, wherein the event-based handling information 401 indicates one or more trigger events and one or more traffic treatments and/or treatment configurations corresponding to each trigger event. The method 1700 further comprises a step 1702 of determining an event-based handling configuration 402 based on the event-based handling information. Further, the method 1700 comprises a step 1703 of providing the event-based handling configuration 402 to a network entity 410, wherein the event-based handling configuration 402 indicates the network entity 410 to perform event-based traffic handling for traffic from the application. Possibly, the network entity 410 may be the network entity shown in FIG. 4 or FIG. 5.

FIG. 18 shows a method 1800 according to an embodiment of the disclosure, particularly for performing event-based traffic handling. In a particular embodiment, the method 1800 is performed by the network entity 410 shown in FIG. 4 or FIG. 5. The method 1800 comprises a step 1801 of obtaining event-based handling configuration 402 from a control entity 400 or a management entity, wherein the event-based handling configuration 402 indicates the network entity 410 to perform event-based traffic handling for traffic from an application. Then, the method 1800 further comprises a step 1802 of performing event-based traffic handling for traffic from the application, based on the event-based handling configuration 402. Possibly, the control entity 400 may be the control entity shown in one of FIG. 4, FIG. 5, and FIG. 6.

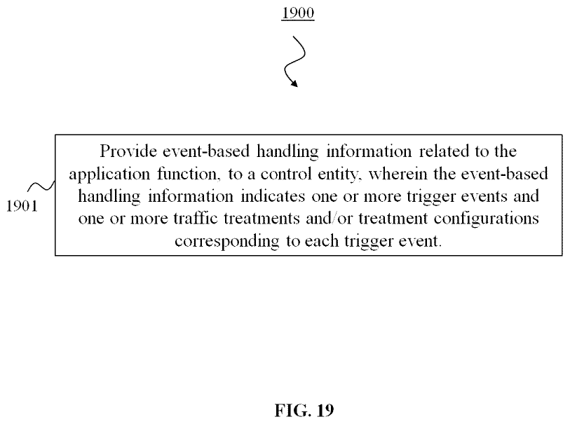

FIG. 19 shows a method 1900 according to an embodiment of the disclosure, particularly for assisting event-based traffic handling. In a particular embodiment, the method 1800 is performed by the AF 420 shown in FIG. 6. The method 1900 comprises a step 1901 of providing event-based handling information 401 related to an application, to a control entity 400, wherein the event-based handling information 401 indicates one or more trigger events and one or more traffic treatments and/or treatment configurations corresponding to each trigger event. Possibly, the control entity 400 may be the control entity shown in one of FIG. 4, FIG. 5, and FIG. 6.

To summarize, this disclosure proposes methods and apparatus for supporting customized event-based traffic handling, where the network is able to control the traffic treatment according to application configuration based on UP events (i.e., receiving of a certain type of PDU/PDU sets). which comprise:

Embodiments of the present application propose:
1. An application network entity (e.g., AF 420 as shown in FIG. 6) configures the network on event-based traffic handling by provision to CP network entity event-based handling information which defines certain traffic handling (e.g., packet drop) for certain PDU(s) (i.e., target PDU(s)) under a certain application event (e.g., send a certain type of PDU/PDU set).
2. CP network entities (e.g., control entity 400 as shown in FIG. 4) determine the Event based Handling Configuration (EbHC), and instruct the UP on performing certain traffic treatments, detection of the certain application event, identification of the target PDU(s) and provides to UPF.
3. A UP network entity (e.g., network entity 410 as shown in FIG. 5) enforces the determined traffic treatments/configurations on certain PDU(s) upon the detection of a certain type of PDU/PDU set.

The related signaling includes interaction between AF and CP network entities; interaction between CP network entities, and interaction between CP network entity and UP network entity.

In one example, EbHI can be implemented as a mapping table which consists of a list of application-specified application trigger events, the correspondent traffic treatment, and the target PDU(s).

The EbHC can be implemented as UP entity configurations/rules/extended QoS profile, which indicate certain traffic treatments/configurations on target PDU(s) upon the detection of specified application trigger event (e.g., a certain type of PDU/PDU set). More specifically, the contents of EbHC include configurations/rules for a certain traffic treatment, configurations/rules for the detection of the application trigger event, configurations/rules for the identification of the target PDUs, and configurations/rules for the marking of the detected application trigger event in the packet header. The EbHC may also include assistance information to map a certain detected application trigger event (e.g., a certain PDU/PDU set type) to an event ID, information to map a certain set of traffic treatment configurations to a network action ID, and/or information to map a certain event-based traffic treatment rule to an event-based handling rule ID.

It can be seen that this disclosure supports event-based handling triggered by the type/importance of the received PDU/PDU set. (UP approach). This solution enables low latency and fast adaptation to the application traffic changes and also reduces network signaling (i.e., no additional CP-UP interaction). In addition, this disclosure also supports event-based handling on selected PDU(s), and customized configuration of event-based handling (from the application/transport). It enables accurate traffic handling, better QoE, and also improves the network resource utilization.

The present disclosure has been described in conjunction with various embodiments as examples as well as implementations. However, other variations can be understood and effected by those persons skilled in the art and practicing the claimed embodiments of the disclosure, from the studies of the drawings, this disclosure, and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutually different dependent claims does not indicate that a combination of these measures cannot be used in an advantageous implementation.

Furthermore, any method according to embodiments of the disclosure may be implemented in a computer program, having code means, which when run by processing means causes the processing means to execute the steps of the method. The computer program is included in a computer-readable medium of a computer program product. The computer-readable medium may comprise essentially any memory, such as a ROM (Read-Only Memory), a PROM (Programmable Read-Only Memory), an EPROM (Erasable PROM), a Flash memory, an EEPROM (Electrically Erasable PROM), or a hard disk drive.

Moreover, it is realized by the skilled person that embodiments of the control entity 400 or the network entity 410 comprise the necessary communication capabilities in the form of e.g., functions, means, units, elements, etc., for performing the solution. Examples of other such means, units, elements, and functions are processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, trellis-coded modulation (TCM) encoder, TCM decoder, power supply units, power feeders, communication interfaces, communication protocols, etc. which are suitably arranged together for performing the solution.

Especially, the processor(s) of the control entity 400 or the network entity 410 may comprise, e.g., one or more instances of a Central Processing Unit (CPU), a processing unit, a processing circuit, a processor, an Application Specific Integrated Circuit (ASIC), a microprocessor, or other processing logic that may interpret and execute instructions. The expression “processor” may thus represent a processing circuitry comprising a plurality of processing circuits, such as, e.g., any, some, or all of the ones mentioned above. The processing circuitry may further perform data processing functions for inputting, outputting, and processing of data comprising data buffering and device control functions, such as call processing control, user interface control, or the like.

What is claimed is:

1. A control entity for controlling event-based traffic handling, the control entity comprising:
a memory storing instructions; and
a processor configured to execute the instructions to cause the control entity to:
obtain event-based handling information related to an application, wherein the event-based handling information indicates one or more trigger events and one or more traffic treatments and/or one or more treatment configurations corresponding to each trigger event of the one or more trigger events;
determine an event-based handling configuration based on the event-based handling information; and
provide the event-based handling configuration to a network entity, wherein the event-based handling configuration indicates the network entity to perform event-based traffic handling for traffic from the application.

2. The control entity according to claim 1, wherein the processor is further configured to execute the instructions to cause the control entity to:
obtain the event-based handling information from an application function via a network exposure function and/or a user data repository function; or
obtain the event-based handling information based on information preconfigured in the control entity.

3. The control entity according to claim 1, wherein the event-based handling information comprises one or more of the following information:
a description of a trigger event and/or an event identifier (ID) indicating a trigger event;
one or more traffic treatments corresponding to a trigger event or an event ID; or
one or more treatment configurations corresponding to a trigger event or an event ID.

4. The control entity according to claim 3, wherein the one or more trigger events comprise one or more of the following events:
a packet or a packet set carrying an event ID with a certain value;
a packet or a packet set of a certain type; or
a packet or a packet set of certain importance.

5. The control entity according to claim 4, wherein a type of a packet or a packet set comprises:
a packet or a packet set carrying an instantaneous decoder refresh (IDR) frame;
a packet or a packet set carrying a full intra-frame request (FIR);
a packet or a packet set indicating a negative acknowledgment; or
a retransmitted packet or a retransmitted packet set.

6. The control entity according to claim 3, wherein the one or more traffic treatments corresponding to a trigger event comprise one or more of the following:
adjust one or more parameters related to a target packet or a target packet set;
adjust one or more parameters related to handling a target packet or a target packet set;
drop a target packet or a target packet set;
preempt a target packet or a target packet set; and
manage a queue storing a target packet or a target packet set.

7. The control entity according to claim 3, wherein the one or more treatment configurations comprise one or more of the following:
criteria for selecting one or more target packets or target packet sets;
timeout or extend a dropping timer for the one or more target packets or the target packet sets;
prioritize or deprioritize the one or more target packets or the target packet sets; or
adjust one or more quality of service (QoS) parameters related to the one or more target packets or the target packet sets.

8. The control entity according to claim 7, wherein the criteria for selecting the one or more target packets or the target packet sets comprises one or more of the following:
flow level criteria comprising flow information or traffic description;
packet or packet set level criteria comprising one or more of: transmission status, QoS parameter, a type of a packet or a packet set, or importance of a packet or a packet set;
temporal criteria comprising a waiting time of a packet or a packet set in the queue and/or arrival time of a packet or a packet set;
criteria to exclude a packet or a packet set that triggers a trigger event; or
criteria to select a packet or a packet set with relative parameters to the packet or the packet set that triggers the trigger event.

9. The control entity according to claim 8, wherein the target packet or the target packet set comprises one or more packets or packet sets that satisfy one or more of the criteria for selecting the one or more target packets or the target packet sets.

10. The control entity according to claim 1, wherein the event-based handling configuration indicates the network entity to perform one or more traffic treatments and/or configurations on one or more target packets or one or more target packet sets based on detecting the one or more trigger events.

11. The control entity according to claim 10, wherein the event-based handling configuration comprises one or more of the following:
a configuration or rule for a certain traffic treatment;
a configuration or rule for detecting the one or more trigger events;
a configuration or rule for identifying the one or more target packets or the one or more target packet sets;
a configuration or rule for marking the detected one or more trigger events in a packet header;
assistance information to map a certain detected trigger event to an event identifier (ID);
information to map one or more traffic treatments or one or more treatment configurations to a network action ID; or
information to map a certain configuration or rule for a certain traffic treatment to an event-based handling rule ID.

12. The control entity according to claim 1, wherein the network entity is an access network entity, and wherein the processor is further configured to execute the instructions to cause the control entity to:
provide the event-based handling information and/or the event-based handling configuration to the access network entity using a session modification procedure.

13. A network entity for performing event-based traffic handling, the network entity comprising:
a memory storing instructions; and
a processor configured to execute the instructions to cause the network entity to:
obtain event-based handling configuration from a control entity or a management entity, wherein the event-based handling configuration indicates the network entity to perform event-based traffic handling for traffic from an application; and
perform event-based traffic handling for traffic from the application, based on the event-based handling configuration.

14. The network entity according to claim 13, wherein the processor is further configured to execute the instructions to cause the network entity to:
perform, based on the event-based handling configuration, one or more traffic treatments and/or one or more treatment configurations on one or more target packets or one or more target packet sets based on detecting one or more trigger events.

15. The network entity according to claim 14, wherein the event-based handling configuration comprises one or more of the following:
a configuration or rule for a certain traffic treatment;
a configuration or rule for detecting the one or more trigger events;
a configuration or rule for identifying the one or more target packets or the one or more target packet sets;
a configuration or rule for marking the detected one or more trigger events in a packet header;
assistance information to map a certain detected trigger event to an event identifier (ID);
information to map one or more traffic treatments or one or more treatment configurations to a network action ID; or
information to map a certain configuration or rule for a certain traffic treatment to an event-based handling rule ID.

16. The network entity according to claim 14, wherein the one or more trigger events comprise one or more of the following events:
a packet or a packet set carrying an event identifier (ID) with a certain value;
a packet or a packet set of a certain type; or
a packet or a packet set of a certain importance.

17. The network entity according to claim 16, wherein a type of a packet or a packet set comprises:
a packet or a packet set carrying an instantaneous decoder refresh (IDR) frame;
a packet or a packet set carrying a full intra-frame request (FIR);
a packet or a packet set indicating a negative acknowledgment; or
a retransmitted packet or a retransmitted packet set.

18. The network entity according to claim 14, wherein the one or more traffic treatments comprise one or more of the following:
adjust one or more parameters related to a target packet or a target packet set;
adjust one or more parameters related to handling a target packet or a target packet set;
drop a target packet or a target packet set;
preempt a target packet or a target packet set; or
manage a queue storing a target packet or a target packet set.

19. The network entity according to claim 14, wherein the processor is further configured to execute the instructions to cause the network entity to:
detect the one or more trigger events; and
identify the one or more target packets or the one or more target packet sets.

20. A method for controlling event-based traffic handling, the method comprising:
obtaining event-based handling information related to an application, wherein the event-based handling information indicates one or more trigger events and one or more traffic treatments and/or one or more treatment configurations corresponding to each trigger event of the one or more trigger events;
determining an event-based handling configuration based on the event-based handling information; and
providing the event-based handling configuration to a network entity, wherein the event-based handling configuration indicates the network entity to perform event-based traffic handling for traffic from the application.
